(19) United States
(12) Patent Application Publication
(10) Pub. No.: US 2012/0065885 A1
(43) Pub. Date: Mar. 15, 2012

(54) MAINTENANCE SUPPORT DEVICE AND IMAGE FORMING SYSTEM

(76) Inventors: Mikiko IMAZEKI, Kanagawa (JP); Yasushi Nakazato, Tokyo (JP); Osamu Satoh, Kanagawa (JP); Masahide Yamashita, Tokyo (JP); Jun Yamane, Kanagawa (JP); Kohji Ue, Kanagawa (JP); Masaichi Sawada, Tokyo (JP)

(21) Appl. No.: 13/223,745

(22) Filed: Sep. 1, 2011

(30) Foreign Application Priority Data
Sep. 14, 2010 (JP) 2010-205170

(51) Int. Cl. G06F 19/00

(52) U.S. Cl. 702/1

(57) ABSTRACT

A maintenance support device, supporting a maintenance work by providing a maintenance worker with information useful for a maintenance object, includes: a data storage unit; a characteristic acquiring unit that acquires a narrowing-down useful characteristic value; an information receiving unit that receives maintenance execution information; a storage process executing unit that executes a process of storing the maintenance execution information in association with execution timing information; and a graph image providing unit that forms a graph image in which a graph indicating a change in a plurality of narrowing-down useful characteristic values and a mark representing the execution timing are drawn in two dimensional coordinates including a value axis which is a coordinate axis for representing a value magnitude of the narrowing-down useful characteristic value and an operation axis which is a coordinate axis for representing the number of operation times or an operation time of the maintenance object.

### CROSS-REFERENCE TO RELATED APPLICATIONS

The present application claims priority to and incorporates by reference the entire contents of Japanese Patent Application No. 2010-205170 filed in Japan on Sep. 14, 2010.

### BACKGROUND OF THE INVENTION

1. Field of the Invention

The present invention relates to a maintenance support device that supports a maintenance work by providing a maintenance worker with information useful for the maintenance of a maintenance object; and an image forming system including the maintenance support device and an image forming device that is a maintenance object.

2. Description of the Related Art

In the past, failures occurring in various devices available on the market are broadly categorized into ones which are simple to determine the causes and can be recovered by a simple maintenance work; and ones which are difficult to determine the causes and cannot be handled by those who are not professional technicians. In the former failure case, a device may detect abnormality of components thereof and issue a maintenance request message of the content such as “please replace OO,” and thus have a user do a maintenance work service. On the other hand, in the latter failure case, only the serviceman can deal with the failure. For example, in an image forming device that forms an image by an electrophotography system, when a certain kind of trouble occurs in a charging system that uniformly charges a photosensitive element, an abnormal image such as a black stripe is generated. In a case where this kind of abnormal image is generated, it is extremely difficult for the user to figure out that the failure is attributable to trouble in the charging system, and accordingly it is common to request the serviceman for repairing it.

However, there may be a case in which even the serviceman is difficult to accurately specify an underlying cause which results in abnormal images. For example, that black stripes described above may be generated due to a secondary cause that makes a charging potential of the photosensitive element unstable; but there may be another cause, a primary cause, leading to the secondary cause. Among a plurality of primary causes such as degradation in charging ability due to deterioration of the photosensitive element, a malfunction of the charging unit, a malfunction of a photosensitive element cleaning device, and the like, at least one of those is associated with the black stripe. The serviceperson can easily specify that the black stripe is generated due to the secondary cause such as unstable charging potential of the photosensitive element. In many cases, however, it is difficult to clearly determine which one, from among the photosensitive element; the charging unit; the photosensitive element cleaning device; and the like, is associated with the primary cause leading to the secondary cause. In this case, a component that is the primary cause has to be specified by trial and error, for example, by replacing the photosensitive element having a most conspicuous with small flaw on trial and then performing test printing.

Even though trial and error is inevitable, it is desirable to immediately specify the primary cause by the trial and error. However, redundant repeats of trial and error for a long period are likely to be unavoidable sometimes. Furthermore, you may encounter an event in which a black stripe occurs only when the user performs a large amount of printing but a noticeable black stripe does not appear when the service man perform test printing by several tens of sheets on the spot. In that case, for example, when the photosensitive element is replaced on trial, even though the primary cause of the black stripe is a component other than the photosensitive element, the black stripe does not occur by a small amount of test printing, and accordingly it is difficult to judge whether or not it has been perfectly repaired. For this reason, the maintenance work has to finish with an explanation given to the user such that the repair may be imperfect. Thereafter, when the photosensitive element is not the primary cause of the black stripe, the black stripe reappears when a large amount of printing is performed. In this case, the user may be dissatisfied even with a highly expensive on-site service provided by the serviceman; hence the user feels a sense of distrust for the repair.

Meanwhile, there has been conventionally known a failure prediction method of periodically acquiring a variety of characteristic values from an image forming device and using them for failure prediction. For example, Japanese Patent Application Laid-open No. 2010-049285 discloses a failure prediction method of judging whether or not an image forming device is in a predictive failure state in which a failure will occur soon by periodically sampling a characteristic value such as photosensitive-element charging potential, the toner density, or the image density from the image forming device and conducting multivariable analysis. According to this failure prediction method, before a failure actually occurs, the user can be informed of that a failure may occur soon.

However, even though it can be predicted in advance that a black stripe may occur soon by the failure prediction method, it is difficult to specify which one from among the photosensitive element; the charging unit; and the like, is the primary cause. For this reason, the serviceman can prepare the photosensitive element or the like in advance for a black stripe that may occur before long; but there is a possibility that it is forced to perform trial and error for a long time on a maintenance work in which a black stripe has actually occurred, similarly to a case in which a prediction is not made in advance.

In the case in which a maintenance work conducted on trial is not appropriate, if it is possible to know it before a symptom (for example, a black stripe) reappears, the user's mistrust can be mitigated by quickly conducting another maintenance work. The present inventors have thought that sampling data of photosensitive-element charging potential or the like may be used as a clue to see whether or not a maintenance work conducted on trial is appropriate. Specifically, when it is detected that a black stripe may occur soon by the failure prediction method, photosensitive-element charging potential is not in a state which is unstable as much. In contrast, when a black stripe actually occurs after that, photosensitive-element charging potential probably shows very unstable behavior. If the unstable behavior continues even after the maintenance, it can be judged that the maintenance work conducted on trial has been inappropriate.

The present inventors has conducted an experiment for finding out a relation between behavior of photosensitive-element charging potential and the propriety of the maintenance work using a printer testing machine. As a result, the followings have been found out. FIG. 1 is a graph illustrating an example of a relation between photosensitive-element charging potential and the number of prints in a printer testing machine in a normal state. In the printer testing machine of the normal state, as illustrated in FIG. 1, it is understood that photosensitive-element potential is stable around −640 [V]. Here, the reason why a horizontal axis represents the number of prints is because in the case of a device with a driving system such as a printer, an operation time or the number of operation times rather than an elapsed time more accurately reflects a state of the device. The photosensitive-element charging potential has been subjected to sampling for every thousand of sheets.

FIG. 2 is a graph illustrating an example of a relation between photosensitive-element charging potential and the number of prints in a printer testing machine in a state in which the charging system has trouble. Even though the charging system has trouble, when days in which printing per day is a relatively small number of prints are consecutive over several days, the graph does not greatly move up and down during that time but shifts around −640 [V]. However, when a large amount of printing is performed during daytime, the graph greatly moves up, so that the photosensitive-element charging potential decreases down to about −610 [V]. At this time, a black stripe occurs. Thereafter, if a print test is suspended during nighttime, the next day the photosensitive-element charging potential is restored up to around −650 [V], so that the graph steeply moves down. Even though the maintenance work has been performed, when such a very rugged graph appears later, it is understood that it can be judged that the maintenance work has been inappropriate.

By the way, when the graph does not undulate but is stable, it has been realized that it is difficult to judge whether or not the maintenance work is appropriate. For example, let us assume that when about two days elapse after the maintenance work has been performed, data of photosensitive-element charging potential during that time period has been collected from the user's image forming device at the user's place. Further, let us assume that a graph illustrated in FIG. 3 has been acquired based on the data. In the graph illustrated in FIG. 3, since a most recent graph spot does not undulate but is stable, it seems that a normal state has been restored at a first glance. However, there is a possibility that the reason why the most recent graph spot is stable is not because the charging system has been normally restored but because the number of prints performed during daytime has been small. A time period, during which a graph spot that does not undulate but is stable has been obtained, corresponds to a time period in which the number of prints is about 28,000. If all of about 28,000 prints have been performed in a state after the maintenance, it can be understood that a large amount of printing of about 14,000 per day has been performed. Thus, it can be judged that the graph has been stable not because the number of prints is small but because the normal state has been restored. However, it cannot be said that all of about 28,000 prints have been performed in the state after the maintenance. There is also a possibility that only second half of about 28,000 prints have been performed in the state after the maintenance work. Even thought the most recent graph spot is stable as illustrated in FIG. 3, it is difficult to judge that the previously performed maintenance work has been appropriated only based on that fact.

A problem arising when the serviceman performs the maintenance work has been described hereinbefore; but when the user familiar with a machine personally performs the maintenance work without relying on the serviceman, the following problem arises. That is, since it is difficult to quickly judge the propriety of the maintenance work performed on trial, there is a problem in that a black stripe repetitively reappears. Further, a maintenance work for resolving the black stripe has been described in detail; but even when a maintenance work for resolving another abnormal image or a maintenance work for repairing a failure showing a symptom different from an abnormal image is performed, a similar problem may occur. Further, even in a maintenance work for performing the maintenance on another maintenance object as well as a maintenance work of an image forming device, a similar problem may occur.

### SUMMARY OF THE INVENTION

It is an object of the present invention to at least partially solve the problems in the conventional technology.

According to an aspect of the present invention, there is provided a maintenance support device that supports a maintenance work by providing a maintenance worker with information useful for maintenance of a maintenance object, including: a data storage unit that stores data; a characteristic acquiring unit that acquires a narrowing-down useful characteristic value, which is a characteristic value periodically acquired from the maintenance object and is stored in the data storage unit and which is a characteristic value useful to narrow down the range of components associated with failures among various components mounted in the maintenance object up to several components at least in view of behavior directly before the failure occurs when the failure occurs in the maintenance object, every time when the maintenance object performs an operation by a predetermined number of times; an information receiving unit that receives maintenance execution information representing that a maintenance work has been performed on the maintenance object; a storage process executing unit that executes a process of storing the maintenance execution information received by the information receiving unit into the data storage unit in association with execution timing information representing timing at which the maintenance work has been performed; and a graph image providing unit that forms a graph image in which a graph indicating a change in a plurality of narrowing-down useful characteristic values stored in the data storage unit and a mark representing the execution timing are drawn, based on data stored in the data storage unit, in two dimensional coordinates including a value axis which is a coordinate axis for representing a value magnitude of the narrowing-down useful characteristic value and an operation axis which is a coordinate axis for representing the number of operation times or an operation time of the maintenance object and provides the maintenance work with the graph image.

According to another aspect of the present invention, there is provided an image forming system, including: an image forming device that forms an image; and a maintenance support device that supports the maintenance of the image forming device which is a maintenance object, wherein the maintenance support device set forth above is used as the maintenance support device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a graph illustrating an example of a relation between photosensitive-element charging potential and the number of prints in a printer testing machine in a normal state;

FIG. 2 is a graph illustrating an example of a relation between photosensitive-element charging potential and the number of prints in a printer testing machine in a state in which a charging system has trouble;

FIG. 3 is a graph illustrating an example of a relation between photosensitive-element charging potential and the number of prints after a maintenance work;

FIG. 4 is a graph illustrating an example of a relation between a narrowing-down useful characteristic value and the number of operation times of a maintenance object after a maintenance work;

FIG. 5 is a schematic configuration diagram illustrating a copying machine which is a maintenance support object for a maintenance support device according to an embodiment;

FIG. 6 is an enlarged configuration diagram illustrating a printer unit of the same copying machine;

FIG. 7 is a partially enlarged diagram illustrating part of a tandem unit of the same printer unit;

FIG. 8 is a block diagram illustrating part of an electrical circuit of the same copying machine;

FIG. 9 is a connection diagram illustrating a connection state of various devices in an image forming system according to an embodiment;

FIG. 10 is a diagram illustrating a graph image formed by the same maintenance support device;

FIG. 11 is a diagram illustrating maintenance information detailed display of the same graph image;

FIG. 12 is a diagram illustrating a second example of the same graph image and maintenance information detailed display;

FIG. 13 is a diagram illustrating a third example of the same graph image and maintenance information detailed display;

FIG. 14 is a schematic diagram illustrating a menu screen of an operation display unit of the same copying machine; and

FIG. 15 is a schematic diagram illustrating a component list display screen of the same operation display unit.

### DETAILED DESCRIPTION OF THE PREFERRED EMBODIMENTS

Hereinafter, a description will be made in connection with exemplary embodiments in which the present invention is applied to an image forming system including an electrophotography copying machine (hereinafter, referred to simply as “copying machine”) which is an image forming device and a maintenance support device that supports the maintenance thereof.

First, a description will be made in connection with a basic configuration of a copying machine of an image forming system according to an embodiment. FIG. 5 is a schematic configuration diagram illustrating a copying machine in an image forming system according to an embodiment. The copying machine includes an image forming unit configured with a printer unit 100 and a paper feeding unit 200, a scanning unit 300, and a document feeding unit 400. The scanning unit 300 is mounted above the printer unit 100; and the document feeding unit 400 configured with an automatic document feeder (ADF) is mounted above the scanning unit 300.

The scanning unit 300 scans image information of an original placed on a contact glass 32 through a scanning sensor 36 and transmits the scanned image information to a control unit (not shown). The control unit controls, for example, a laser or a light-emitting diode (LED) (not shown) arranged inside an exposing device 21 of the printer unit 100 based on the image information received from the scanning unit 300 so that four drum-like photosensitive elements 40K, 40Y, 40M, and 40C can be irradiated with laser writing light L. Through this irradiation, electrostatic latent images are formed on the surfaces of the photosensitive elements 40K, 40Y, 40M, and 40C; and the latent images are developed into toner images through a predetermined developing process. The suffixes K, Y, M, and C added after reference number indicate the specification for black, yellow, magenta, and cyan.

The printer unit 100 includes primary transfer rollers 62K, 62Y, 62M, and 62C, a secondary transfer device 22, a fixing device 25, an ejecting unit, a toner supply device (not shown), and the like in addition to the exposing device 21.

The paper feeding unit 200 includes an automatic paper feeding unit arranged below the printer unit 100 and a bypass unit arranged on the side of the printer unit 100. The automatic paper feeding unit includes two paper cassettes 44 that are arranged in multiple steps in a paper bank 43, a paper feeding roller 42 that takes a transfer sheet as a recording body out of the paper cassette 44, and a separating roller 45 that separates the taken transfer sheet and sends the transfer sheet to a feed path 46. The automatic paper feeding unit further includes a carriage roller 47 that conveys the transfer sheet to a feed path 48 of the printer unit 100 or the like. The bypass unit includes a bypass tray 51, a separating roller 52 that separates the transfer sheets on the bypass tray 51 one by one toward a bypass feed path 53, and the like.

A pair of registration rollers 49 is arranged near the end of the feed path 48 of the printer unit 100. The pair of registration rollers 49 receives the transfer sheet sent from the paper cassette 44 or the bypass tray 51 and then sends the transfer sheet to a secondary transfer nip formed between an intermediate transfer belt 10 as an intermediate transfer body and the secondary transfer device 22 at predetermined timing.

An operator sets an original on a platen 30 of the document feeding unit 400 at the time of copying a color image. Alternatively, the document feeding unit 400 is opened, an original is set on the contact glass 32 of the scanning unit 300, and thereafter the original is pressed by closing the document feeding unit 400. Then, a start switch (not shown) is pressed. After the original is conveyed onto the contact glass 32 when the original is set on the document feeding unit 400 and when the original is set on the contact glass 32, the scanning unit 300 immediately starts to drive. A first traveling body 33 and a second traveling body 34 travel; and light emitted from a light source of the first traveling body 33 is reflected against a surface of the original and then directed toward the second traveling body 34. Further, the light is reflected by a mirror of the second traveling body 34; then reaches the scanning sensor 36 via an imaging lens 35; and scanned as image information.

As described above, when the image information is scanned, the printer unit 100 rotationally drives one of support rollers 14, 15, and 16 by a driving motor (not shown) while allowing the remaining two support rollers to be rotationally driven. The intermediate transfer belt 10 stretched by these rollers is moved in an endless manner. Further, laser writing described above or a developing process which will be described later is executed. Further, monochromatic images of black, yellow, magenta, and cyan are formed while the photosensitive elements 40K, 40Y, 40M, and 40C are rotating. The monochromatic images are sequentially superimposed and electrostatically transferred at the primary transfer nips for K, Y, M, and C at which the photosensitive elements 40K, 40Y, 40M, and 40C come in contact with the intermediate transfer belt 10, so that a four-color superimposed toner image is formed. The toner images are formed on the photosensitive elements 40K, 40Y, 40M, and 40C.

Meanwhile, in order to feed the transfer sheet of the size according to the image information, the paper feeding unit 200 operates any one of three paper feeding rollers and guides the transfer sheet to the feed path 48 of the printer unit 100. The transfer sheet that has entered into the feed path 48 stops, sandwiched between the pair of registration rollers 49, and is fed to the secondary transfer nip which is a contact section between the intermediate transfer belt 10 and a secondary transfer roller 23 of the secondary transfer device 22 at a synchronized timing. Thus, at the secondary transfer nip, the four-color superimposed toner image on the intermediate transfer belt 10 is synchronized with and comes in close contact with the transfer sheet. Due to influence of a transfer electric field or nip pressure formed at the nip, the four-color superimposed toner image is secondarily transferred onto the transfer sheet to thereby form a full color image together with white color of the paper.

The transfer sheet that has passed the secondary transfer nip is fed to the fixing device 25 by endless movement of a conveying belt 24 (secondary transfer belt) of the secondary transfer device 22. After the full-color image is fixed by the action of pressing by a pressing roller 27 of the fixing device 25 and heating by a heating belt, the transfer sheet is discharged onto a discharge tray 57 disposed at the side of the printer unit 100 via a discharging roller 56.

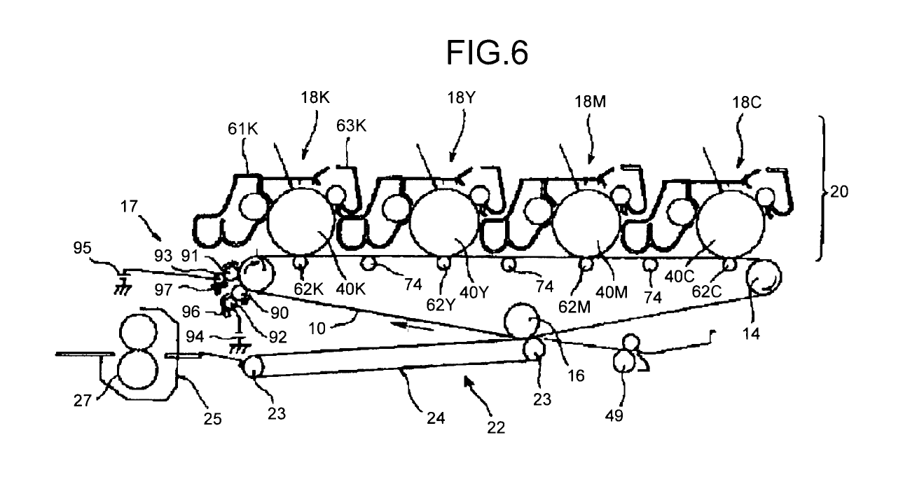

FIG. 6 is an enlarged configuration diagram illustrating the printer unit 100. The printer unit 100 includes a belt unit, four processing units 18K, 18Y, 18M, 18C that form toner images of respective colors, the secondary transfer device 22, a belt cleaning device 17, the fixing device 25, and the like.

The belt unit moves the intermediate transfer belt 10 stretched by a plurality of rollers in an endless manner while making the intermediate transfer belt 10 come in contact with the photosensitive elements 40K, 40Y, 40M, and 40C. At primary transfer nips for K, Y, M, and C at which the photosensitive elements 40K, 40Y, 40M, and 40C come in contact with the intermediate transfer belt 10, the primary transfer rollers 62K, 62Y, 62M, and 62C press the intermediate transfer belt 10 from the back surface side toward the photosensitive elements 40K, 40Y, 40M, and 40C. A primary transfer bias is applied to each of the primary transfer rollers 62K, 62Y, 62M, and 62C by a power supply (not shown). Accordingly, a primary transfer electric field that electrostatically moves the toner images on the photosensitive elements 40K, 40Y, 40M, and 40C toward the intermediate transfer belt 10 is formed at the primary transfer nips for K, Y, M, and C. Conductive rollers 74 coming in contact with the back surface of the intermediate transfer belt 10 are arranged between the primary transfer rollers 62K, 62Y, 62M, and 62C, respectively. The conductive rollers 74 prevent the primary transfer bias applied to the primary transfer rollers 62K, 62Y, 62M, and 62C from flowing into the adjacent processing units via a base layer having intermediate resistance disposed at the back surface side of the intermediate transfer belt 10.

Each of the processing units 18K, 18Y, 18M, and 180 is one in which the photosensitive element 40K, 40Y, 40M, or 40C and several other devices are supported in a common support body as a single unit, and are attachable to or detachable from the printer unit 100. For example, the processing unit 18K for black includes a developing unit 61K as a developing means for developing the electrostatic latent image formed on the surface of the photosensitive element 40K into a black toner image in addition to the photosensitive element 40K. The processing unit 18K for black further includes a photosensitive-element cleaning device 63K that cleans residual transfer toner, which has passed through the primary transfer nip, attached to the surface of the photosensitive element 40K. The processing unit 18K for black further includes a neutralization device (not shown) that neutralizes the cleaned surface of the photosensitive element 40K, a charging device (not shown) that uniformly charges the neutralized surface of the photosensitive element 40K, and the like. The processing units 18Y, 18M, and 18C for other colors have substantially the same configuration except that color of the toner to be handled is different. The present copying machine has a so-called tandem type configuration in which the four processing units 18K, 18Y, 18M, and 18C are arranged in parallel to face to the intermediate transfer belt 10 along an endless movement direction.

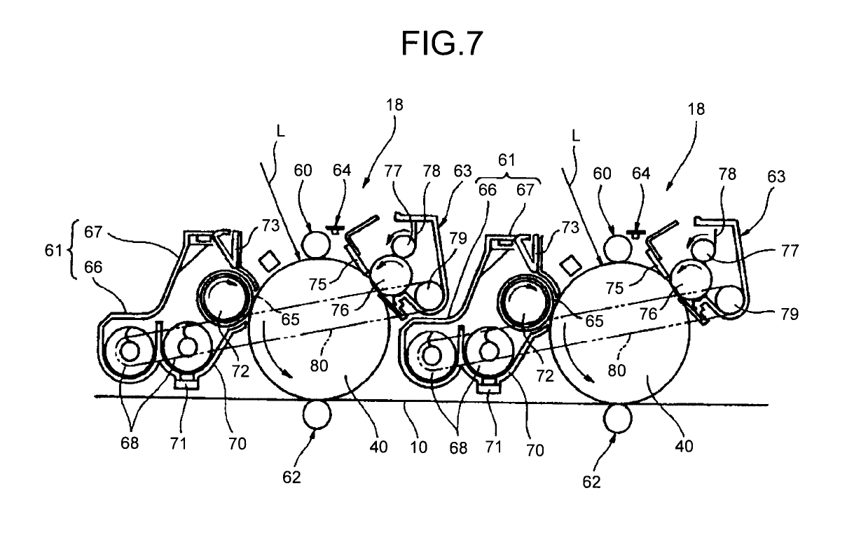

FIG. 7 is a partially enlarged diagram illustrating part of a tandem unit 20 including the four processing units 18K, 18Y, 18M, and 18C. Since the four processing units 18K, 18Y, 18M, and 18C have substantially the same configuration except for the color of the toner to use, the suffixes K, Y, M, and C attached to the reference numerals are omitted from FIG. 7. As illustrated in FIG. 7, the processing unit 18 includes a charging device 60 as a charging unit, the developing device 61, the primary transfer roller 62 as a primary transfer unit, the photosensitive-element cleaning device 63, a neutralization device 64, and the like, which are disposed around the photosensitive element 40.

As the photosensitive element 40, used is a drum-like one having a photosensitive layer which is formed by coating a tube made of aluminum or the like with an organic photosensitive material having photosensitivity. Further, an endless belt-like one may be used. As the charging device 60, used is one which rotates a charging roller to which a charging bias is applied while making the charging roller come in contact with the photosensitive element 40. Further, there may be used a scorotron charger or the like which performs a charging process on the photosensitive element 40 in a non-contact manner.

The developing device 61 is configured to develop a latent image using a two-component developer containing a magnetic carrier and non-magnetic toner. The developing device 61 includes a stirring unit 66 that supplies the two-component developer contained thereinside to a developing sleeve 65 by conveying it while stirring the two-component developer and a developing unit 67 that allows the toner in the two-component developer attached to the developing sleeve 65 to be transferred onto the photosensitive elements 40K, 40Y, 40M, and 40C.

The stirring unit 66 is disposed at the position lower than the developing unit 67. The stirring unit 66 includes two screws 68 arranged in parallel to each other, a partition plate disposed between the screws 68, a toner density sensor 71 disposed at the bottom surface of a developing case 70, and the like.

The developing unit 67 includes the developing sleeve 65 facing the photosensitive element 40 via an opening of the developing case 70; a magnetic roller 72 which is non-rotatably disposed inside the developing sleeve 65; a doctor blade 73 that approaches its forefront to the developing sleeve 65, and the like. A gap between the doctor blade 73 and the developing sleeve 65 is set to about 500 micrometers at the most approached portion. The developing sleeve 65 has a sleeve form that is capable of non-magnetic rotation. The magnetic roller 72 configured not to follow the rotation of the developing sleeve 65 includes, for example, five magnetic poles N1, S1, N2, S2, and S3 in a rotation direction of the developing sleeve 65 from the position of the doctor blade 73. The magnetic poles apply magnetic force to the two-component developer on the sleeve at a predetermined position in the rotation direction, respectively. Accordingly, the two-component developer sent from the stirring unit 66 is attracted to and carried on the surface of the developing sleeve 65; and a magnetic brush is formed on the sleeve surface along the line of magnetic force.

The thickens of the magnetic brush is restricted to the appropriate thickness when passing through the position facing the doctor blade 73 with the rotation of the developing sleeve 65 and then conveyed to a developing area facing the photosensitive element 40. Due to the potential difference between the developing bias applied to the developing sleeve 65 and the electrostatic latent image of the photosensitive element 40, the two-component developer is transferred to the electrostatic latent image and contributes to development. Further, the two-component developer is returned to the inside of the developing unit 67 again with the rotation of the developing sleeve 65; is removed from the sleeve surface due to influence of a repulsive magnetic field between the magnetic poles of the magnetic roller 72; and then is returned to the stirring unit 66. Inside the stirring unit 66, an appropriate amount of toner is supplied to the two-component developer based on a detection result by the toner density sensor 71. As the developing device 61, one using a one-component developer containing no magnetic carrier may be employed instead of one using the two-component developer.

As the photosensitive-element cleaning device 63, used is a type in which a cleaning blade 75 made of polyurethane rubber comes in press contact with the photosensitive element 40; but another type may be used. In order to increase cleaning performance, in this example, employed is the photosensitive-element cleaning device 63 including a fur brush 76 which has a contact conductivity and is rotatable in a direction of an arrow in FIG. 7 and of which outer circumferential surface comes in contact with the photosensitive element 40. An electric field roller 77 that is made of metal and applies a bias to the fur brush 76 is disposed to be rotatable in a direction of an arrow in FIG. 7; and the front end of a scraper 78 comes in press contact with the electric field roller 77. A toner removed from the electric field roller 77 by the scraper 78 falls onto a collection screw 79 and collected.

The photosensitive-element cleaning device 63 having this configuration removes the toner remaining on the photosensitive element 40 by the fur brush 76 rotating in a counter direction to the photosensitive element 40. The toner attached to the fur brush 76 is removed by the electric field roller 77 which rotates in a counter direction to the fur brush 76 while coming in contact with the fur brush 76 and to which a bias is applied. The toner attached to the electric field roller 77 is cleaned by the scraper 78. The toner collected by the photosensitive-element cleaning device 63 is brought to one side of the photosensitive-element cleaning device 63 by the collection screw 79, returned to the developing device 61 by a recycling device 80, and then reused.

The neutralization device 64 includes a neutralization lamp and the like and irradiates light to neutralize a surface potential of the photosensitive element 40. The surface of the photosensitive element 40 neutralized as described above is uniformly charged by the charging device 60 and then subjected to an optical writing process.

The secondary transfer device 22 is disposed below the belt unit in FIG. 6. In the secondary transfer device 22, the secondary transfer belt 24 is stretched between two rollers 23 and moves in an endless manner. One of the two rollers 23 functions as a secondary transfer roller to which a secondary transfer bias is applied by a power supply (not shown), and the intermediate transfer belt 10 and the secondary transfer belt 24 are sandwiched between the secondary transfer roller and the roller 16 of the belt unit. Thus, formed is a secondary transfer nip at which both belts move in the same direction while coming in contact with each other. The four-color superimposed toner image on the intermediate transfer belt 10 is collectively secondary-transferred onto the transfer sheet fed to the secondary transfer nip from the pair of registration rollers 49, due to influence of a secondary transfer electric field or nip pressure, so that a full color image is formed on the transfer sheet. The transfer sheet that has passing through the secondary transfer nip is separated from the intermediate transfer belt 10 and conveyed to the fixing device 25 with the endless movement of the belt while being held on the surface of the secondary transfer belt 24. Further, instead of the secondary transfer roller, the secondary transfer may be performed by a transfer charger or the like.

The surface of the intermediate transfer belt 10 that has passed through the secondary transfer nip reaches the support position by the support roller 15. The intermediate transfer belt 10 is sandwiched between the belt cleaning device 17 that comes in contact with its front surface (a loop outer surface) and the support roller 15 that comes in contact with its back surface. The residual transfer toner attached to the front surface is removed by the belt cleaning device 17. Thereafter, the intermediate transfer belt 10 sequentially enters the primary transfer nips for K, Y, M, and C; and next four color toner images are superimposed.

The belt cleaning device 17 includes two fur brushes 90 and 91. The fur brushes 90 and 91 mechanically scrape the residual transfer toner on the belt by rotating a plurality of napped fibers in a counter direction to an implantation direction while coming in contact with the intermediate transfer belt 10. In addition, a cleaning bias is applied by a power supply (not shown), and so the scrapped residual transfer toner is electrostatically attracted and collected.

Metal rollers 92 and 93 rotate in a forward or reverse direction while coming in contact with the fur brushes 90 and 91, respectively. Of the metal rollers 92 and 93, a negative voltage is applied by a power supply 94 to the metal roller 92 positioned at the upstream side of the intermediate transfer belt 10 in the rotation direction. Further, a positive voltage is applied by a power supply 95 to the metal roller 93 positioned at the downstream side. Front ends of blades 96 and 97 come in contact with the metal rollers 92 and 93, respectively. In this configuration, the fur brush 90 at the upstream side first cleans the surface of the intermediate transfer belt 10 with the endless movement of the intermediate transfer belt 10 in an arrow direction in FIG. 6. At this time, for example, when −700 [V] is applied to the metal roller 92 and −400 [V] is applied to the fur brush 90, a toner of a positive polarity on the intermediate transfer belt 10 is first electrostatically transferred to the fur brush 90 side. The toner transferred to the fur brush side is further transferred from the fur brush 90 to the metal roller 92 due to the potential difference and scrapped off by the blade 96.

The toner on the intermediate transfer belt 10 is removed by the fur brush 90 in the above described manner; but a lot of toner still remains on the intermediate transfer belt 10. The toner is charged to a negative polarity by a negative bias applied to the fur brush 90. Then, by applying a positive bias and cleaning using the fur brush 91 at the downstream side, the toners can be removed. The removed toner is transferred from the fur brush 91 to the metal roller 93 due to the potential difference and scrapped off by the blade 97. The toner scrapped off by the blades 96 and 97 is collected in a tank (not shown).

Although most of toners have been removed, a small amount of toner still remains on the surface of the intermediate transfer belt 10 cleaned by the fur brush 91. The toner remaining on the intermediate transfer belt 10 is charged to a positive polarity by a positive bias applied to the fur brush 91 in the above described manner. Then, the toner is transferred onto the photosensitive elements 40K, 40Y, 40M, and 40C by a transfer electric field applied at the primary transfer position and then collected by the photosensitive-element cleaning device 63.

The pair of registration rollers 49 is usually used in a grounded state; but a bias may be applied to the pair of registration rollers 49 so as to remove paper powder of the transfer sheet P.

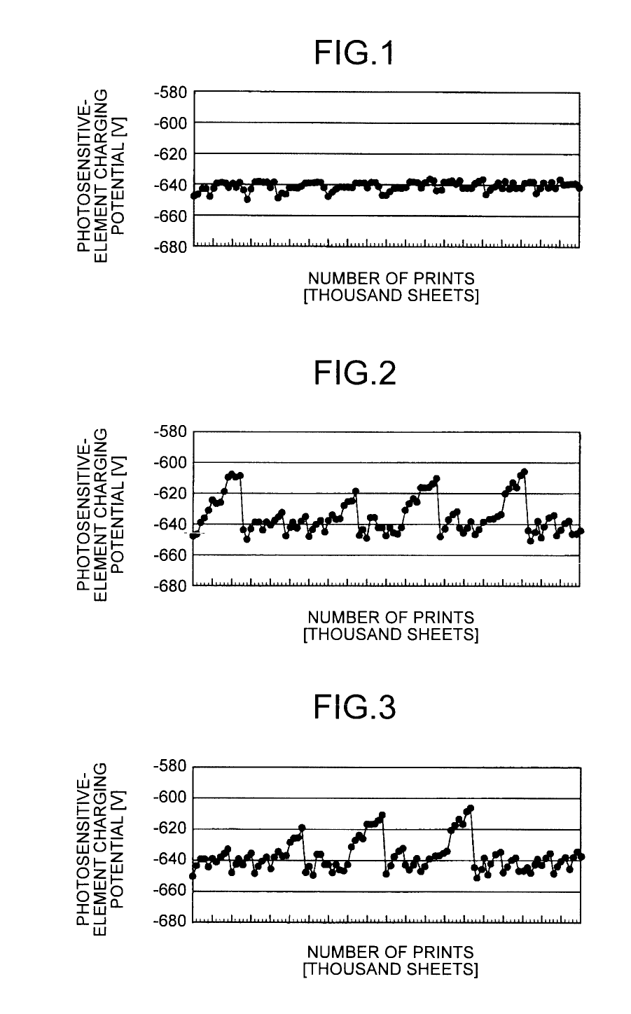

Below the secondary transfer device 22 and the fixing device 25, disposed is a transfer sheet reversing device 28 (see FIG. 1) that extends in parallel to the tandem unit 20. The path of the transfer sheet in which the image fixing process has been completed on its one surface is switched to the transfer sheet reversing device side by a switching claw; and the transfer sheet is reversed by the transfer sheet reversing device and enters the secondary transfer nip again. The secondary transfer process and the fixing process of an image are executed even on the other surface; and then the transfer sheet is discharged to the discharge tray.

In the copying machine having the above described configuration, an image forming unit that forms an image on the transfer sheet which is a recording medium is configured with the processing units 18K, 18Y, 18M, and 180, the secondary transfer device 22, the exposure device 21, and the like.

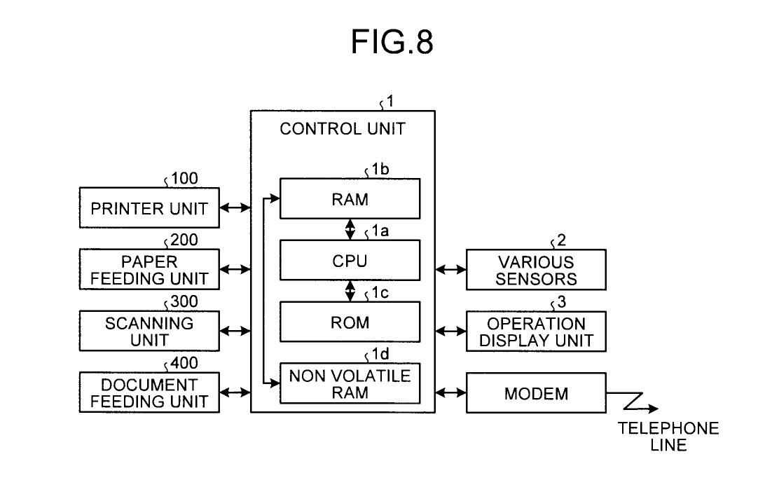

Some of the components of the copying machine function as a characteristic value acquiring unit that periodically acquires a narrowing-down useful characteristic value useful for narrowing down which component among various components mounted in the copying machine is concerned with a failure up to several components at least in view of behavior directly before the failure occurs when the failure occurs in the copying machine. The characteristic value acquiring unit is configured with a control unit 1, various sensors 2, an operation display unit 3, and the like, which are illustrated in FIG. 8. The control unit 1 is a control means that is in charge of control of the whole copying machine. The control unit 1 includes a read only memory (ROM) 1c as a data storage unit for storing a control program, a random access memory (RAM) 1b as a data storage unit for storing calculation data, a control parameter, and the like, a central processing unit (CPU) 1a as a calculation unit, a non-volatile RAM 1d as a data storage unit, and the like. The operation display unit 3 includes a display unit 3a (touch display unit) configured with a liquid crystal display (LCD) or the like for displaying character information or the like and an operation unit 3b that receives input information from an operator through a numeric keypad or the like and transmits the character information or the like to the control unit 1.

The characteristic value acquiring unit including the control unit 1 and the like acquires a plurality of narrowing-down useful characteristic values such as photosensitive-element charging potential. Examples of the narrowing-down useful characteristic values include sensing information, control parameter information, input information, and image reading information. A description will be made below in connection with these pieces of information.

a: Sensing Information

As for the sensing information, a driving relation, various characteristics of a recording medium, a developer characteristic, a photosensitive element characteristic, various processing states of electrophotography, an environmental condition, various characteristics of a recording object, and the like are considered as an acquisition object. A description will be made below in connection with an overview of these pieces of sensing information.

a-1: Driving Information

The rotating speed of the photosensitive element is detected by an encoder; a current value of a driving motor is read; or the temperature of the driving motor is read.

Similarly, detected is a driving state of a cylindrical or belt-like rotating component such as the fixing roller, the paper carriage roller, and the driving roller.

A sound generated by driving is detected by a microphone installed inside or outside the device.

a-2: Paper Conveying State

Through a transmissive or reflective optical sensor or a contact type sensor, the occurrence of a paper jam is detected by reading the position of the front end or the rear end of the conveyed paper; and deviation of timing at which the front end or the rear end of the paper passes through, a variation in a direction vertical to a feeding direction, or the like is read.

Similarly, the moving speed of the paper is obtained in view of a plurality of detection timings between a plurality of sensors.

Slippage between the paper feeding roller and the paper at the time of paper feeding is obtained by comparing a rotation number measurement value of the paper feeding roller with a movement amount of the paper.

a-3: Various Characteristics of Recording Medium such as Paper

This information has great influence on the image quality or sheet conveying stability. Information related to the paper type may be acquired by the following methods.

The paper thickness is obtained by interposing the paper between two rollers and detecting a relative positional displacement of the rollers through an optical sensor or the like or by detecting the amount of displacement equal to the movement amount of a member pushed up when the paper enters.

The surface roughness of the paper is obtained by bringing a guide to comes in contact with the surface of the non-transferred paper and detecting a vibration or a sliding sound generated by the contact.

The glossiness of the paper is obtained by allowing light flux having a specified opening angle to be incident at a specified incidence angle and measuring light flux having the specified opening angle reflected in a specular reflection direction by a sensor.

The rigidity of the paper is obtained by detecting the deformation amount (the curvature amount) of the pressed paper.

A judgment on whether or not the paper is a recycled paper is performed by irradiating the paper with ultraviolet light and detecting the transmittance thereof.

A judgment on whether or not the paper is a backing paper is performed by irradiating light from a linear light source such as a light emitting diode (LED) array and detecting light reflected against the transfer surface through a solid state image sensing device such as a charge coupled device (CCD).

A judgment on whether or not the paper is an overhead projector (OHP) sheet is performed by irradiating the paper with light and detecting regularly reflected light having an angle different from transmitted light.

The moisture content of the paper is obtained by measuring absorption of infrared light or micro wave light.

The amount of curls is detected by an optical sensor, a contact sensor, or the like.

The electrical resistance of the paper is directly measured by brining a pair of electrodes (for example, the paper feeding rollers) to come in contact with the recording sheet; or the surface potential of the photosensitive element or the intermediate transfer body after paper transfer is measured, and electrical resistance of the recording sheet is estimated from the value.

a-4: Developer Characteristic

A characteristic of the developer (toner and carrier) inside the device has influence on the basis of a function of an electrophotography process. For this reason, it is an important factor for an operation or output of a system. It is very important to obtain information of the developer. For example, examples of the developer characteristic include the following items.

As for the toner, there may be included the charged amount, the distribution thereof, flowability, cohesion, the bulk density, electrical resistance, the amount of external additives, the consumed amount, the remaining amount, and the toner density (a mixing ratio of the toner and the carrier).

As for the carrier, there may be included a magnetic characteristic, the coating film thickness, the spent amount, and the like. Usually, it is difficult to individually detect these pieces of information in the image forming device. It is desirable to detect an overall character of the developer. For example, the overall characteristic of the developer may be measured as follows.

Measured is the reflection density (optical reflectance) of a toner image which is formed by forming a test latent image on the photosensitive element and developing it under a predetermined developing condition.

A pair of electrodes is disposed in the developing device, and a relation between an applying voltage and a current is measured (resistance, dielectric constant, or the like).

A coil is disposed in the developing device, and a voltage-current characteristic (inductance) is measured.

A level sensor is disposed in the developing device, and the developer capacity is detected. As the level sensor, an optical type, a capacitance type, and the like are used.

a-5: Photosensitive Characteristic

Similarly to the developer characteristics, the photosensitive element characteristic also closely relate to the electrophotography process function. Examples of information of the photosensitive element characteristics include the film thickness of the photosensitive element, the surface characteristics (a frictional coefficient or irregularity), uniform charging potential, surface energy, scattering light, temperature, color, surface position (deflection), linear speed, potential attenuation speed, electrical resistance, capacitance, surface moisture content, and the like. From among these examples, the following information may be detected in the image forming device.

A variation in capacitance accompanying a change in the film thickness is detected by detecting a current flowing from a charging member to the photosensitive element and simultaneously comparing a voltage applied to the charging member with the voltage-current characteristic relating to a preset dielectric thickness of the photosensitive element to determine the film thickness.

The uniform charging potential and the temperature may be obtained by a known conventional sensor.

The linear speed is detected by an encoder or the like attached to a rotating shaft of the photosensitive element.

The scattering light from the surface of the photosensitive element is detected by an optical sensor.

a-6: State of the Electrophotography Process

As is known, toner image formation by electrophotography is performed by a succession of processes including: uniform charging of the photosensitive element; latent image formation (image exposure) using laser light or the like; development using a toner (coloring particles) with an electric charge; transfer of a toner image onto a transfer material (in the case of a color image, this is performed by superimposing toner images onto an intermediate transfer body or a recording medium which is a final transfer body, or by superimposition development onto the photosensitive element at the time of development); and fixing of the toner image onto the recording medium. The various pieces of information at each of these stages greatly affect an image and other system outputs. It is important to obtain the various pieces of information in evaluating stability of the system. Specific examples of obtaining information of the electrophotography process state are as follows:

The charging potential and exposure unit potential are detected by a known conventional surface potential sensor.

The gap between a charging member and a photosensitive element in non-contact charging is detected by measuring the amount of light passing through the gap.

The electromagnetic wave caused by charging is perceived by a wideband antenna.

The sound generated by charging.

The exposure intensity.

The exposure optical wavelength.

Various states of the toner image may be obtained by the following methods.

The pile height (height of the toner image) is obtained by measuring the depth in a vertical direction through a displacement sensor and measuring the shielding length in a horizontal direction through a parallel ray linear sensor.

The toner charging amount is measured by a potential sensor that measures potential of an electrostatic latent image of a solid portion and potential when the latent image has been developed, and obtained based on a ratio with an adhesion amount converted by a reflection density sensor in the same location.

Dot fluctuation or scattering is obtained by detecting a dot pattern image through an infrared light area sensor on the photosensitive element and area sensors of wavelengths corresponding to respective colors on the intermediate transfer body and then performing appropriate processing.

The offset amount (after fixing) is obtained by reading locations corresponding to the surface of a recording sheet and the surface of the fixing roller through optical sensors, respectively, and comparing the two obtained sensor values.

The remaining transfer amount is judged by disposing optical sensors (on the PD and the belt) after the transfer process and measuring the amount of reflected light from a transfer pattern remaining after the transfer of a specific pattern.

Color unevenness at the time of superimposition is detected by a full color sensor that detects the surface of the recording sheet after fixing.

a-7: Characteristics of Formed Toner Image

The image density and color are optically detected. Either of reflected light and transmitted light may be used. The projection wavelength may be selected according to the color. In order to obtain the density and monochromatic information, the detection may be performed on the photosensitive element or the intermediate transfer body; but in order to measure a color combination such as color unevenness, the detection needs be performed on the sheet.

Gradation is detected by detecting the reflection density of the toner image formed on the photosensitive element or the toner image transferred onto the transfer body at each gradation level by an optical sensor.

Sharpness is obtained by reading an image in which a line repeating pattern is developed or transferred using a monocular sensor with a small spot diameter or a high resolution line sensor.

Granularity (feeling of roughness) is obtained by reading a halftone image and calculating a noise component in the same method as detection of sharpness.

Optical sensors are disposed at both ends in a main scanning direction after registration, and a registration skew is obtained based on a difference between ON timing of the registration rollers and detection timing of the two sensors.

Color deviation is detected by detecting an edge portion of a superimposed image on an intermediate transfer body or a recording sheet through a monocular small-diameter spot sensor or a high resolution line sensor.

Banding (density unevenness in a conveying direction) is detected by measuring density unevenness in a sub scanning direction on a recording sheet through a small-diameter spot sensor or a high resolution line sensor and measuring the signal amount at a specific frequency.

Glossiness (unevenness) is detected by a regular reflection-type optical sensor disposed to detect a recording sheet on which a uniform image is formed.

Fogging is detected by a method of reading an image background portion through an optical sensor for detecting a comparatively wide region on a photosensitive element, an intermediate transfer body, or a recording sheet or a method of obtaining image information for each area of the background region through a high resolution area sensor and counting the number of toner particles contained in the image.

a-8: Physical Characteristics of Print Object in Image Forming Device

Image deletion/fading or the like is determined by detecting a toner image on a photosensitive element, an intermediate transfer body, or a recording sheet through an area sensor and subjecting the obtained image information to image processing.

Toner scattering is obtained by obtaining an image on a recording sheet through a high resolution line sensor or an area sensor and calculating the amount of toner scattered around a pattern portion.

Rear end blank spots and betacross blank spots are detected through a high resolution line sensor on a photosensitive element, an intermediate transfer body, or a recording sheet.

Curling, rippling, and folding of a recording sheet are detected through a displacement sensor. It is effective to install a sensor in a location close to both end portions of the recording sheet so as to detect folding.

Contamination or a scratch of an edge surface is detected by capturing an image of the edge surface and analyzing the image when a certain amount of discharge sheets have been accumulated through an area sensor vertically disposed in a discharge tray.

a-9: Environmental Condition

For detection of the temperature, the following system and elements may be employed: a thermocouple system which extracts as a signal a thermoelectromotive force generated at a contact point at which two different metals or a metal and a semiconductor are joined; a resistivity variation element using the fact that resistivity of a metal or semiconductor varies depending on the temperature; a pyroelectric element in which, in a certain type of crystal, an arrangement of charges inside a crystal is polarized by an increase in temperature to generate potential on the surface; and a thermomagnetic effect element which detects a change in magnetic property depending on the temperature.

For detection of humidity, an optical measurement method that measures optical absorption of H2O or an OH group, a humidity sensor that measures a change in electric resistance value of a material due to absorption of water vapor, or the like may be employed.

Various gases are detected by measuring a change in electric resistance of an oxide semiconductor basically accompanying adsorption of gas.

For detection of airflow (a direction, a flow speed, or a gas type), an optical measuring method or the like may be used; but an air-bridge type flow sensor having a small size is particularly useful when mounting to a system is considered.

For detection of air pressure and pressure, a method of using a pressure sensitive material and measuring mechanical displacement of a membrane may be employed. The same method may be used for detection of oscillation.

b: Control Parameter Information

Since an operation of an image forming device is determined by a control unit, it is effective to directly use input/output parameters of the control unit.

b-1; Image Formation Parameter

Direct parameters output by a calculation process performed by the control unit for the purpose of image formation include the following examples.

A setting value of a process condition set by the control unit, for example, charging potential, a developing bias value, and a fixing temperature setting value.

Similarly, setting values of parameters of various image processing such as halftone processing, color correction.

Various parameters set by the control unit for an operation of the device, for example, sheet conveyance timing, an execution time of a preparatory mode prior to image formation, and the like.

b-2: User Operating History

The frequency of various operations selected by the user such as the number of colors, the number of sheets, an image quality instruction.

The frequency of the sheet size selected by the user.

b-3: Power Consumption

The total power consumption over the entire time period or a specific time period unit (one day, one week, one month, etc.), or the distribution, a variation (differential), and a cumulative value (integral) thereof.

b-4: Information Regarding Consumption of Consumables

A used amount of a toner, a photosensitive element, and a sheet over the entire time period or a specific time period unit (one day, one week, one month, etc.), or the distribution, a variation (differential), and a cumulative value (integral) thereof.

b-5: Information Regarding Occurrence of Failure

The frequency with which a failure occurs (by type) over the entire time period or a specific time period unit (one day, one week, one month, etc.), or the distribution, a variation (differential), and a cumulative value (integral) thereof.

b-6: Cumulative Operating Time Information

The control unit 1 measures a cumulative operating time on each of various components such as the processing unit, the intermediate transfer belt 10, various rollers, the belt cleaning device 17, and the fixing device 25 and stores the cumulative operating time in the non volatile RAM 1d. The processing units 18K, 18Y, 18C, and 18M of respective colors are detachable from or attachable to the copying machine in a state of the processing unit but can be disassembled into the developing unit, the charging unit, and the photosensitive element unit that holds other portions in a state detached from the copying machine. The component replacement may be performed in the form of the developing unit, the charging unit, and the photosensitive element unit other than the entire processing unit. For this reason, the cumulative operating time is measured individually on each of the developing unit, the charging unit, and the photosensitive element unit other than the entire processing unit. The cumulative number of prints is counted as the cumulative operating time. The cumulative number of prints increases by one at each time when a print operation corresponding to one sheet is performed.

c: Input Image Information

The following information may be obtained from image information transmitted from a host computer as direct data or image information obtained after being scanned from an original image by a scanner and being subjected to image processing.

The cumulative number of color pixels is obtained by counting image data of each of GRB signals for each pixel.

For example, using a method described in Japanese Patent No. 2621879, a ratio of a character portion, a halftone portion, and the like can be obtained by dividing an original image into characters, halftone dots, photographs, and the background. A ratio of colored characters can be obtained in a similar manner.

By counting a cumulative value of color pixels for each of regions partitioned in a main scanning direction, the toner consumption distribution in the main scanning direction can be obtained.

The image size is obtained based on an image size signal generated by a control unit or the distribution of color pixels in image data.

A type of a character (the size or a font) is obtained based on attribute data of a character.

Next, a description will be made in connection with a specific method of obtaining a narrowing-down useful characteristic value from a copying machine.

1: Temperature

The copying machine includes a resistance variation element that is simple in principle and configuration and small in size as a temperature sensor for obtaining temperature information.

2: Humidity

A small-sized humidity sensor is useful. The basic principle thereof is that when water vapor is adsorbed to a moisture-sensitive ceramic, ion conduction increases by the adsorbed water, and thus electrical resistance of the ceramic decreases. The moisture-sensitive ceramic material is a porous material such as an alumina-based ceramic, apatite-based ceramic, ZrO2-MgO based ceramic, in general.

3: Oscillation

An oscillation sensor is basically the same as a sensor that measures air pressure and pressure; and an ultra small-sized sensor using silicon is particularly useful if mount to a system is considered. A motion of an oscillator manufactured on a thin silicon diaphragm is measured by measuring a volumetric change between the oscillator and a counter electrode disposed opposite to the oscillator or using a piezo resistance effect of a Si diaphragm itself.

4: Toner Density (for Four Colors)

The toner density is detected for each color. A known conventional sensor may be used as a toner density sensor. For example, the toner density may be detected by a sensing system, disclosed in Japanese Patent Application Laid-open No. H6-289717, which measures a change in magnetic permeability of a developer in a developing device.

5: Uniform Charging Potential Of Photosensitive Element (for Four Colors)

Uniform charging potential is detected on the photosensitive elements 40K, 40Y, 40M, and 40C of respective colors. A known surface potential sensor that detects surface potential of an object may be used.

6: Post-Exposure Potential of Photosensitive Element (for Four Colors)

Surface potential of the photosensitive elements 40K, 40Y, 40M, and 40C after optical writing is detected in a similar manner as that described in (5).

7: Colored Area Ratio (for Four Colors)

A colored area ratio is obtained for each color based on a ratio between a cumulative value of pixels to be colored and a cumulative value of all pixels based on input image information, and the colored area ratio is used.

8: Developing Toner Amount (for Four Colors)

The toner adhesion amount per unit area on toner images of respective colors developed on the photosensitive elements 40K, 40Y, 40M, and 40C is obtained based on optical reflectance obtained by a reflective photosensor. The reflective photosensor irradiates an object with LED light and detects reflected light by a light receiving element. Since a correlation is established between the toner adhesion amount and the optical reflectance, the toner adhesion amount can be determined based on the optical reflectance.

9: Inclination of Front End Position of Paper

A pair of optical sensors that detects a transfer sheet at both ends in a direction orthogonal to a conveying direction are disposed at a certain point on the paper feeding path ranging from the paper feeding roller of the paper feeding unit 200 to the secondary transfer nip; and both side ends of the conveyed transfer sheet near the front end thereof are detected. The two optical sensors measure a time period from the transmission of a driving signal for the paper feeding roller to the complete passage of the transfer sheet, and an inclination of the transfer sheet to the feeding direction is obtained based on a time lag.

10: Paper Ejection Timing

A transfer sheet that has passed through the pair of discharging rollers (56 in FIG. 5) is detected by an optical sensor. Even in this case, measurement is performed based on a time of transmitting the driving signal of the paper feeding roller.

11: Total Current of Photosensitive Element (for Four Colors)

A current is detected that flows from the photosensitive elements 40K, 40Y, 40M, and 40C to the ground. The current may be detected by disposing a current measuring means between a substrate of the photosensitive element and a ground terminal.

12: Driving Power of Photosensitive Element (for Four Colors)

Driving power (currentxvoltage) consumed by the driving source (motor) of a photosensitive element during driving is detected by an ammeter, a voltmeter, or the like.

The control unit 1 periodically performs sampling of various narrowing-down useful characteristic values described above and stores them in the non volatile RAM 1d.

Next, a description will be made in connection with a characteristic configuration of an image forming system according to an embodiment.

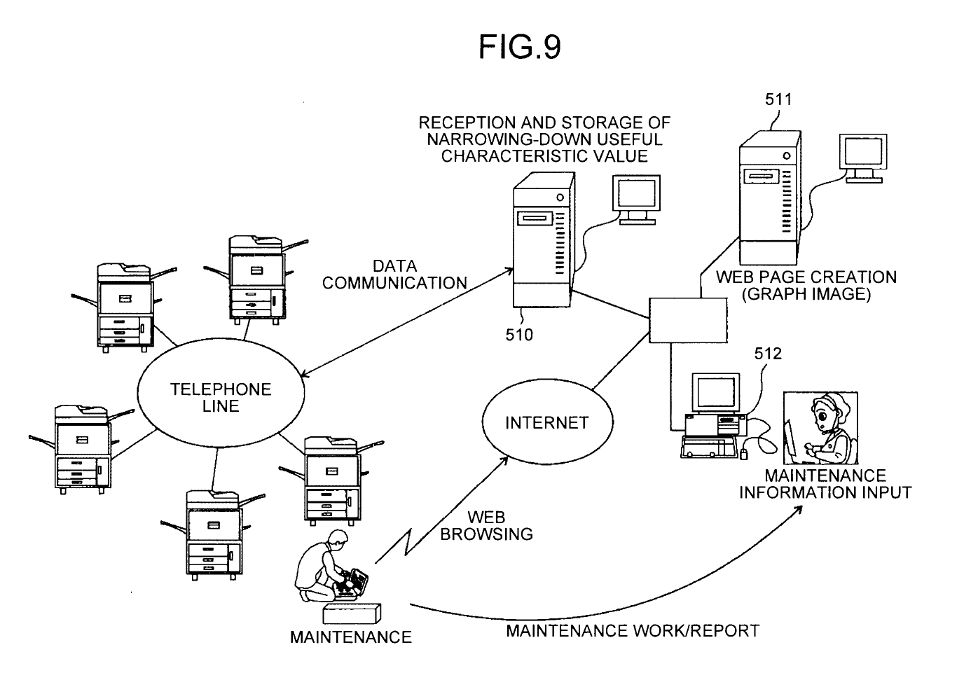

FIG. 9 is a connection diagram illustrating a connection state of various devices in an image forming system according to an embodiment. Referring to FIG. 9, the image forming system includes a plurality of copying machines disposed at different users' places; and the copying machines are connected to a data reception computer 510, which will be described later, through a telephone line. Each of the copying machines includes a characteristic value acquiring unit that is configured with a control unit that constitutes part of the maintenance support device, various sensors, an operation display unit, and the like.

Among various devices in the image forming device according to an embodiment, the copying machine, the characteristic value acquiring unit, and the non volatile RAM that is the data storage unit are installed in the user's place. On the other hand, the data reception computer 510, a web server 511, and a maintenance information management computer 512 are installed in a remote monitoring facility of a maintenance management service provider. The data reception computer 510, the web server 511, and the maintenance information management computer 512 are configured with a known personal computer, respectively, and can be connected to one another through a local area network (LAN) line to perform data communication with one another.

The image forming system according to an embodiment includes a receiving unit that receives data inside the non volatile RAM which is the data storage unit mounted in each copying machine through a telephone line which is a communication line. The receiving unit is configured with a modem mounted in each copying machine or a modem mounted in the data reception computer 510 which will be described later.

The data reception computer 510 accesses the copying machine of each user through a telephone line at a predetermined time zone once a day. The data reception computer 510 receives various narrowing-down useful characteristic values corresponding to one day stored in the non volatile RAM of each copying machine; classifies the narrowing-down useful characteristic values according to the user; and stores the narrowing-down useful characteristic values in a hard disk (a management data storage unit) thereof. Inside each user's copying machine, narrowing-down useful characteristic value data is stored in a format in which the magnitude of value is associated with sampling date and time. For example, photosensitive-element charging potential is stored in a format such as “−650, 2010/01/01/12:53”. Each of various narrowing-down useful characteristic values is subjected to sampling at intervals of a thousand prints. Thus, one narrowing-down useful characteristic value corresponds to a value corresponding to one thousand prints.

The serviceman that has performed the maintenance work in the user's place returns to the remote monitoring facility and then reports the contents of the maintenance work to an operator through a report. In the maintenance information management computer 512 arranged in the remote monitoring facility, installed is a maintenance management database through which data management according to each user can be performed. The operator that has received the report from the serviceman inputs the contents of the maintenance work performed by the serviceman to a field of a corresponding user name in the maintenance management database.

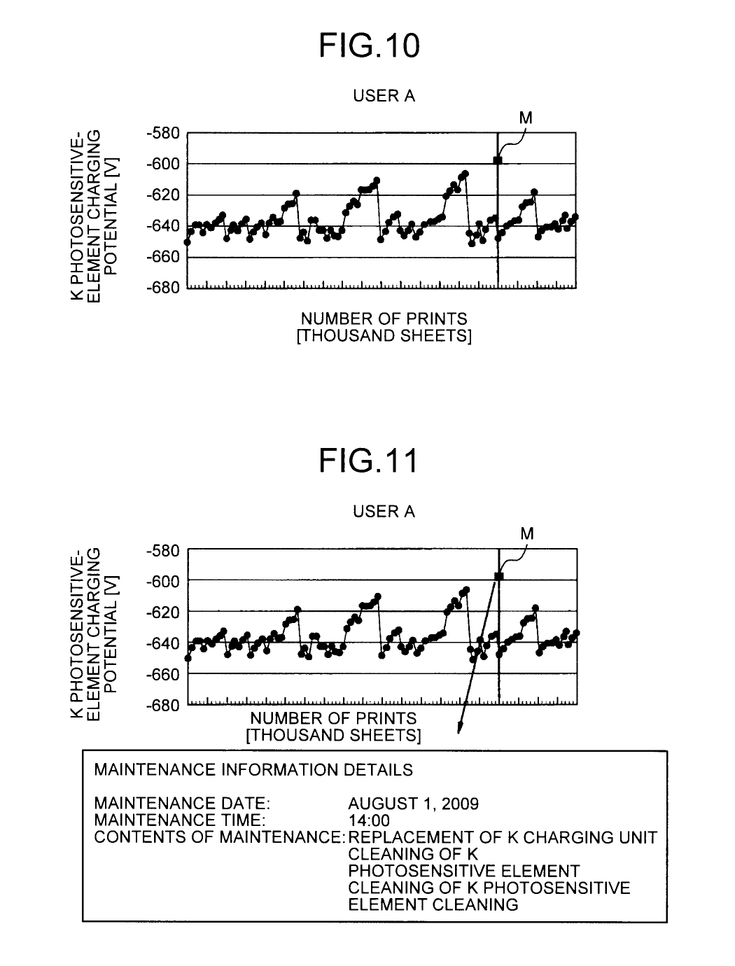

The web server 511 constructs a graph image provided on a world wide web (WEB) page based on data stored in a hard disk of the data reception computer 510 and data input to the maintenance management database of the maintenance information management computer 512. The graph image refers to an image in which a graph representing behavior of a narrowing-down useful characteristic value such as photosensitive-element charging potential and a mark representing execution timing of the maintenance work performed by the serviceman are drawn. The graph is one in which narrowing-down useful characteristic value data is plotted in two-dimensional coordinates having a value of a narrowing-down useful characteristic value as a vertical axis and the number of prints as the number of operation times as a horizontal axis. Forming the graph image starts based on the fact that the maintenance worker's command signal is received through the Internet. Specifically, the serviceman can perform data communication with the web server connected to the Internet by accessing the Internet through a portable telephone line or a personal handy phone system (PHS) line through a portable information terminal such as a personal data assistant (PDA) or a mobile PC. In the case of desiring to know behavior of charging potential corresponding to past 100,000 prints on the photosensitive element for K in the user A's copying machine, a signal representing that intention is transmitted. The web server that has received the signal accesses the data reception computer 510 on the user A's copying machine and receives data corresponding to past 100 prints on K photosensitive-element charging potential in the user A's copying machine. After lining up the data in time series, the graph plotted on the two dimensional coordinates is formed. A time period between a graph start point and a graph end point is perceived based on acquisition date and time of the oldest data among the data corresponding to past 100 prints and acquisition date and time of the newest data. Then, maintenance work information related to the maintenance work executed within the time period on the user A's copying machine is received from the maintenance information management computer 512. Next, among data corresponding to 100 prints, specified is data whose timing corresponds to maintenance execution timing of the received maintenance work information. For example, when the maintenance execution timing was “2009/12/15:14:24”, among data corresponding to 100 prints, data that is prior to the maintenance execution timing and has been subjected to sampling at most recent timing is specified from among data corresponding to 100 prints. A mark representing maintenance execution timing is added to a plotting position of the data in the two dimensional coordinates. In this way, for example, on K photosensitive-element charging potential of the user A's copying machine, the graph image illustrated in FIG. 10 is formed and stored in the hard disk as a web page; and the graph image is transmitted to the serviceman's portable information terminal through the Internet. As a result, the graph image of FIG. 10 is displayed on a screen of the serviceman's portable information terminal.

When the serviceman, who has referred to the graph image of FIG. 10, clicks a mark M representing maintenance execution timing, a transmission command of the maintenance work contents corresponding to the mark M is transmitted from the serviceman's portable information terminal by a link plastered in the mark M. The transmission command is received by the web server 511 through the Internet. The web server 511 that has received the transmission command of the maintenance work contents receives information of the maintenance work content corresponding to the mark M from the maintenance information management computer 512. A process of superimposing the received data on the graph image is executed, and thereafter, the superimposed graph image is transmitted to the serviceman's portable information terminal. Thus, the graph image illustrated in FIG. 11 is displayed on the screen of the serviceman's portable information terminal.

The serviceman who has referred to the graph image can notice that the replacement work of the K charging unit previously performed has been inappropriate since the K charging unit has been replaced but the graph spot following that has undergone a lot of changes.

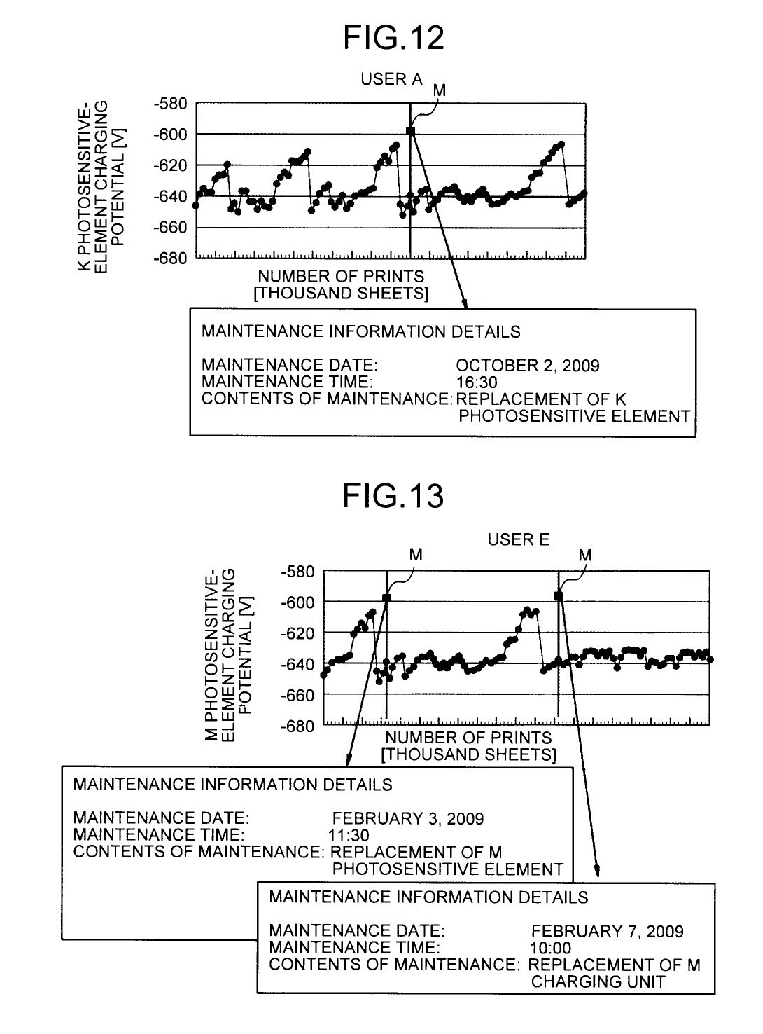

The serviceman can not only display the graph image to see whether or not the performed maintenance work has been appropriate, but also display the graph image to investigate the maintenance work that has to be performed. For example, let us assume that a black stripe has occurred in the user A's place, and so the K photosensitive element has been replaced on trial. After two days, when the graph image of charging potential of the K photosensitive element has been displayed, since the graph has been stable even though a large amount of printing has been performed during the two days, it has been judged that the maintenance work appropriate for the replacement of the K photosensitive element has been performed, and repair completion has been reported to the operator. However, after three days, a report representing that a black stripe has reoccurred has been received from the user A. When the graph image of K photosensitive-element charging potential of the user A has been displayed, the graph image illustrated in FIG. 12 has been obtained. It can be understood that after the K photosensitive element has been replaced, the graph has been stable for a while; but thereafter the graph has undergone a lot of changes again. Since the graph has been stable directly after the K photosensitive element has been replaced even though the number of prints per day has been much, it has been judged as “repaired”; but thereafter the graph has undergone a lot of changes. For this reason, it has been difficult to judge whether the replacement work of the K photosensitive element has been really right. In this case, the serviceman can check whether or not a similar case has occurred in another user's copying machine. Specifically, the serviceman displays the graph image of each photosensitive-element charging potential on another user's copying machine and checks whether or not there has been a case in which the graph has been first stable after the photosensitive element replacement and thereafter there has been a lot of changes again.

As a result, a similar case has been found in a graph image illustrated in FIG. 13. In this case, the M photosensitive-element charging potential has been stable after the M photosensitive element has been replaced; but since a lot of changes have occurred and a stripe image of M color has been generated, a serviceman different from the serviceman who is in charge of the user A has performed a maintenance work again in a user E's place. At this time, the M charging unit has been replaced, and so thereafter photosensitive-element charging potential has been reliably stable. The serviceman, in charge of the user A, who has referred to that graph image, notices that a black strip reoccurred since the K charging unit has been replaced can be solved in this case. This case may actually occur. If the charging unit is contaminated by a discharge product such as a nitric acid compound, the charging function deteriorates, and the charging ability deteriorates since a nitric acid compound is attached to the photosensitive element. If the photosensitive element is replaced with a new one in this state, the charging ability of the photosensitive element is restored, and thus charging potential temporarily becomes stable. However, since the photosensitive element is immediately contaminated by the charging unit that causes a large amount of discharge product to be attached to, charging potential greatly changes after a short time.

In the image forming system according to an embodiment, the maintenance information management computer 512 functions as an information receiving unit that receives maintenance execution information representing that the maintenance work has been performed on the copying machine; but each copying machine includes an information receiving unit separately from the maintenance information management computer 512. The information receiving unit includes a control unit and an operation display unit. The maintenance execution information may be received such that the operator inputs it to the maintenance information management computer 512 based on the serviceman's report. Alternatively, it may be received such that the user or the serviceman inputs it to the operation display unit.

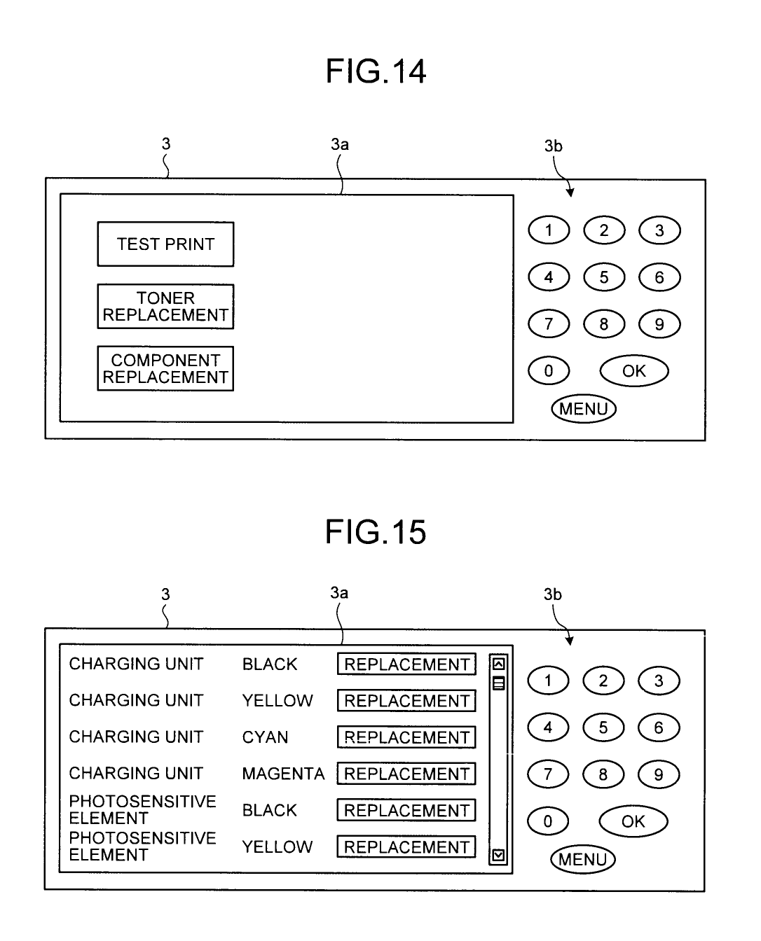

FIG. 14 is a schematic diagram illustrating a menu screen in the operation display unit 3 of the copying machine. The operation display unit 3 includes the touch display unit 3a configured with a touching panel and the key operation unit 3b configured with a numeric keypad. The user or the serviceman can display the menu screen illustrated in FIG. 14 on the touch display unit 3a by pressing a menu key of the key operation unit 3b. Among a plurality of buttons displayed on the menu screen, a component replacement button is tapped (touch operation) by a finger as indicated by an arrow in FIG. 14. As a result, a replacement information input list screen illustrated in FIG. 15 can be displayed on the touch display unit 3a. For example, when the K photosensitive element is replaced, the screen is scrolled as needed so that a character of the K photosensitive element can be displayed on the screen. By tapping the replacement button of the K photosensitive element by a finger, maintenance work information (replacement information) of the K photosensitive element can be input. At this time, information representing that the K photosensitive element has been replaced and information representing replacement execution timing (date and time) are received. The maintenance work information is transmitted to the maintenance information management computer 512 once a day through the data reception computer 511 when data is received by the data reception computer 511.

Further, a graph image providing unit may be configured with the control unit and the operation display unit of each copying machine. That is, the graph image is displayed on the operation display unit of each copying machine.

As described above, in the image forming system according to an embodiment, the characteristic value acquiring unit, which is configured with the control unit, various sensors, the operation display unit, and the like mounted in each copying machine, acquires plurality kinds of narrowing-down useful characteristic values respectively associated with different types of failures. The web server 511 that is the graph image providing unit forms a graph image in which a graph of a narrowing-down useful characteristic value selected by the maintenance worker among plurality kinds of narrowing-down useful characteristic values is drawn. In this configuration, by displaying a graph selected by the user among plurality kinds of graphs, the user can grasp behavior of a narrowing-down useful characteristic value appropriate for a symptom of the copying machine.

Further, in the image forming system according to an embodiment, a combination of a characteristic acquiring unit (for example, a control unit) and a data storage unit (a non volatile RAM) is individually arranged in each user's place so that a narrowing-down useful characteristic value can be individually acquired from each of a plurality of copying machines arranged in different users' places and stored. Further, disposed are a communication unit including a modem or the like which communicates with each data storage unit through a telephone line which is a communication line and receives a narrowing-down useful characteristic value stored in each data storage unit and the maintenance information management computer 512 which is a management data storage unit which stores the narrowing-down useful characteristic value received from each data storage unit to be classified according to the user so as to individually manage the narrowing-down useful characteristic value according to the user. The web server 511 is configured to execute a process of forming a graph image, in which a graph of a narrowing-down useful characteristic value corresponding to a user selected by a serviceman among a plurality of users is drawn, based on data stored in the maintenance information management computer 512. In this configuration, it is possible to select and display a graph image on a plurality of copying machines.

Further, in the image forming system according to an embodiment, the maintenance information management computer 512 or the operation display unit is configured to execute a process of receiving a combination of restoration work execution information of a component and a component name information as maintenance execution information; and the web server 511 is configured to execute a process of synthesizing the restoration work execution information and the component name information on the graph image in addition to the mark M representing the maintenance execution timing based on a command from the user or the serviceman. In this configuration, the user or the serviceman who has referred to the graph image can grasp a component that has been subjected to the maintenance work and the content of maintenance as well as timing at which the maintenance work has been executed.

Further, in the image forming system according to an embodiment, the maintenance information management computer 512 is configured to execute a process of receiving information capable of specifying which, among at least a replacement work and a cleaning work, is the executed restoration work as restoration work execution information. In this configuration, the user or the serviceman who has referred to the graph image can distinctively grasp the replacement work and the cleaning work.

Further, the characteristic value acquiring unit is configured to acquire a physical quantity representing a predetermined characteristic value of a component such as photosensitive-element charging potential as a narrowing-down useful characteristic value. Thus, the serviceman can grasp the secondary cause through a graph representing behavior of the physical quantity.

Further, the characteristic value acquiring unit is configured to acquire a value, which is obtained by normalizing a physical quantity representing a predetermined characteristic value of a component such as a standard deviation of a physical quantity as a narrowing-down useful characteristic value. In this case, the serviceman can grasp the secondary cause through a graph representing behavior of normalized data.

Further, the characteristic value acquiring unit is configured to acquire an abnormal index value representing a degree of abnormality of a component such as Mahalanobis' distance as narrowing-down useful characteristic value. In this case, the serviceman can grasp the secondary cause through a graph representing behavior of an abnormal index value.

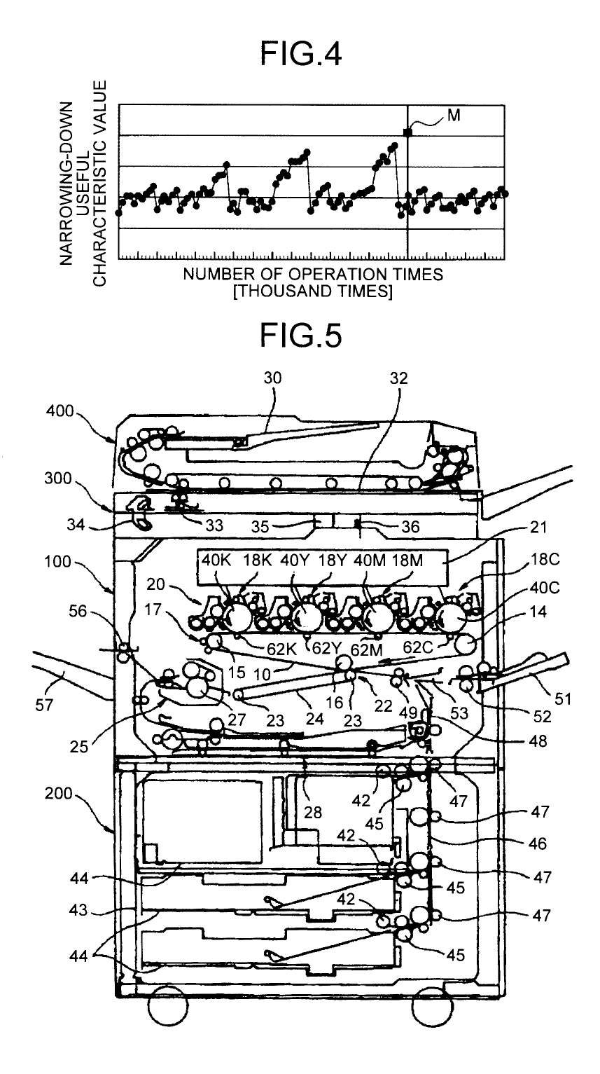

In these inventions, the maintenance worker specifies the number of operation times or an operation time of a maintenance object from a time when the maintenance work is performed to a current time point by referring to a graph image provided by a graph image providing unit. For example, when a graph image illustrated in FIG. 4 is provided, an operation has been performed 25,000 times (=25 plots×1000 times) between a mark M representing execution timing of a maintenance work and a current time point. Since the graph image illustrated in FIG. 4 is checked at timing within a relatively short time period after the maintenance work is executed, the maintenance worker clearly remembers the day on which the maintenance work has been performed. For this reason, for example, when the maintenance work has been executed two days ago, it is possible to easily grasp the most recent operation frequency like “an operation has been performed 12,000 times per day”. Using this grasp result, even though the most recent graph spot is stable, it is possible to easily discriminate the cause of stabilization, that is, whether or not it has been caused by the low operation frequency or whether or not it has been stabilized even though an operation frequency has been high (it has been restored to a normal state). Further, when the operation frequency has been low, by repetitively checking the image graph in a similar manner until a day on which the operation frequency is high comes, it is possible to check whether or not the graph is stable even under the condition in which the operation frequency is high. Through this checking, it is possible to easily judge whether or not a maintenance work performed on trial has been appropriate.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A maintenance support device that supports a maintenance work by providing a maintenance worker with information useful for maintenance of a maintenance object, comprising:
a data storage unit that stores data;
a characteristic acquiring unit that acquires a narrowing-down useful characteristic value, which is a characteristic value periodically acquired from the maintenance object and is stored in the data storage unit and which is a characteristic value useful to narrow down the range of components associated with failures among various components mounted in the maintenance object up to several components at least in view of behavior directly before the failure occurs when the failure occurs in the maintenance object, every time when the maintenance object performs an operation by a predetermined number of times;
an information receiving unit that receives maintenance execution information representing that a maintenance work has been performed on the maintenance object;
a storage process executing unit that executes a process of storing the maintenance execution information received by the information receiving unit into the data storage unit in association with execution timing information representing timing at which the maintenance work has been performed; and
a graph image providing unit that forms a graph image in which a graph indicating a change in a plurality of narrowing-down useful characteristic values stored in the data storage unit and a mark representing the execution timing are drawn, based on data stored in the data storage unit,
in two dimensional coordinates including
a value axis which is a coordinate axis for representing a value magnitude of the narrowing-down useful characteristic value and
an operation axis which is a coordinate axis for representing the number of operation times or an operation time of the maintenance object and
provides the maintenance work with the graph image.

2. The maintenance support device according to claim 1, wherein
the characteristic value acquiring unit acquires a plural kinds of narrowing-down useful characteristic values which are respectively associated with different types of failures, and
the graph image providing unit forms the graph image in which a graph of a narrowing-down useful characteristic value selected by the maintenance worker among the plural kinds of narrowing-down useful characteristic values is drawn.

3. The maintenance support device according to claim 1, wherein:
a combination of a plurality of the characteristic acquiring units and a plurality of the data storage units is individually arranged in each user's place so that the narrowing-down useful characteristic value can be individually acquired from each of a plurality of maintenance objects disposed in different users' places and be stored;
disposed is a communication unit that communicates with each data storage unit via a communication line and receives the narrowing-down useful characteristic value stored in each data storage unit;
disposed is a maintenance data storage unit that stores the narrowing-down useful characteristic value received from each data storage unit to be classified according to a transmitting source so that the narrowing-down useful characteristic values are individually managed for each transmitting source; and
the graph image providing unit is configured to execute a process of forming the graph image, in which a graph of the narrowing-down useful characteristic value corresponding to a transmitting source selected by the maintenance worker among a plurality of transmitting sources is drawn, based on data stored in the maintenance data storage unit.

4. The maintenance support device according to claim 1, wherein:
the information receiving unit is configured to execute a process of receiving a combination of restoration work execution information of a component and a component name information as the maintenance execution information; and
the graph image providing unit is configured to execute a process of synthesizing the restoration work execution information and the component name information on the graph image in addition to the mark representing the execution timing based on a command from the maintenance worker.

5. The maintenance support device according to claim 4, wherein
the information receiving unit is configured to execute a process of receiving information capable of specifying which, among at least a replacement work, a cleaning work, and a repair work, an executed restoration work is as the restoration work execution information.

6. The maintenance support device according to claim 1, wherein
the narrowing-down useful characteristic value is represented by a physical quantity representing a predetermined characteristic value of a component.

7. The maintenance support device according to claim 1, wherein
the narrowing-down useful characteristic value is represented by a value obtained by normalizing a physical amount representing a predetermined characteristic value of a component.

8. The maintenance support device according to claim 1, wherein
the narrowing-down useful characteristic value is an abnormal index value representing a degree of abnormality of a component.

9. An image forming system, comprising:
an image forming device that forms an image; and
a maintenance support device that supports the maintenance of the image forming device which is a maintenance object,
wherein the maintenance support device set forth in claim 1 is used as the maintenance support device.
